(19) United States
(12) Patent Application Publication
(10) Pub. No.: US 2006/0052101 A1
(43) Pub. Date: Mar. 9, 2006

(54) Method for assigning and searching a roaming number of mobile subsribers

(75) Inventor: Yuxiang Zhou, Shenzhen City (CN)

Correspondence Address: FOLEY AND LARDNER LLP;SUITE 500, 3000 K STREET NW, WASHINGTON, DC, 20007, US

(73) Assignee: ZTE Corporation, Shenzhen (CN)

(21) Appl. No.: 10/534,013

(22) PCT Filed: Oct. 21, 2003
(86) PCT No.: PCT/CN03/00880

§ 371 Date: Jul. 19, 2005

(30) Foreign Application Priority Data
Nov. 8, 2002 (CN) 02145166.4

(51) Int. Cl. H04Q 7/20

(52) U.S. Cl. 455/435.1; 455/433

(57) ABSTRACT

The present invention provides a method for assigning and searching a mobile subscriber roaming number, wherein in a Visitor Location Register, the mobile subscriber roaming number is managed by a plurality of Visitor Location Register modules, said method of assigning a mobile subscriber roaming number is characterized in that, said mobile subscriber roaming number comprises a Visitor Location Register module number, and said Visitor Location Register module number is utilized to directly determine the correspondence relationship between said assigned mobile subscriber roaming number and the Visitor Location Register module in said Visitor Location Register that manages said mobile subscriber roaming number.

### TECHNICAL FIELD OF THE INVENTION

The present invention relates to the field of mobile communication, in particular, to assignment and search of a mobile subscriber roaming number.

### BACKGROUND OF THE INVENTION

Generally, a mobile communication system is composed of a BSS (Base Station System), a MSS (Mobile Switching System) and a MS (Mobile Station), as shown in FIG. 1, the MSS generally comprises one or more HLR (Home Location Register), one or more MSC (Mobile Switching Center), one or more VLR (Visitor Location Register), generally, the VLR and the MSC are physically in one, the MSC can be divided into a GMSC (Gateway Mobile-services Switching Center) and a VMSC (Visited MSC) according to its function. The main function of the GMSC is to process the interworking traffic between the MSS and other networks, the VMSC processes MO (Mobile Originated) and MT (Mobile Terminated) service of the MS.

In a mobile communication system, the MSS related system model that relates to a mobile called call process is shown in FIG. 2, the whole process is briefly described as follows:
process \textcircled{1}, the GMSC receives a call request coming from other networks to a MS in the current network;
process \textcircled{2}, the GMSC requests route information from the home HLR of this MS;
process \textcircled{3}, the HLR has stored therein the current VLR number of this MS, then the HLR sends a request to this VLR, requests the VLR to assign a MSRN;
process \textcircled{4}, the VLR is a real time database and has stored therein the current subscription information and location information of this MS, the VLR assigns an unused MSRN and returns it to the HLR according to the usage of the current MSRN (Mobile Subscriber Roaming Number), the VLR must establish the association relationship between the MSRN and the MS information record, generally, this is realized through a MSRN information table, each record in the MSRN information table stores the record number of the MSRN information table;
process \textcircled{5}, the HLR sends the returned MSRN to the GMSC;
process \textcircled{6}, the GMSC continues to establish a call to the MS by utilizing the returned MSRN;
process \textcircled{7}, after the VMSC receives the in call request of the GMSC, it initiates a query to the VLR by utilizing the MSRN, the VLR queries the MSRN information table according to the MSRN, obtains the record number of the MS information table, and queries the MS information table to obtain the current information of the MS, the VLR returns these information to the VMSC and at the same time, releases this MSRN, then the VMSC initiates a call to the BSS that controls this location area, subsequently, the MS receives the call and performs subscriber access, the MS will ring and talk.

During the above processes, the MSRN serves as two functions:
1, route function, which routes the call from the GMSC to the current VMSC of the subscriber;
2, information association function, that is, the MSRN is an association number, and the VLR finds the information of the corresponding MS by utilizing the MSRN.

To achieve the above functions, the MSRN has the same format as a MSISDN (Mobile Subscriber International ISDN Number) and occupies a portion of the MSISDN number resource (that portion of number cannot be assigned to a MS). The format of the MSISDN is as follows:
MSISDN=CC+NDC+SN
wherein, CC: country code, NDC: national district code, SN: subscriber number.

For a MSRN, the SN comprises a MSC portion and a VLR portion, and a MSC number is composed of a NDC and the MSC portion, the VLR portion is the record number of the MSRN information table. So:
MSRN=CC+MSC number+record number of MSRN information table

For example, a MSRN number is: 86139005167123, wherein 86 represents the country code CC for China, 139005167 represents the MSC number, 123 represents the record number of the MSRN information table in the VMSC. CC and the MSC number accomplishes the first function of the MSRN in the above mobile called call (terminal call) processes: for routing a call from the GMSC to the VMSC; the record number of the MSRN information table accomplishes the second function of the above MSRN, it is used by the VLR to locate the MSRN information table, this portion of number is controlled by the VLR. So generally, the VLR has two following tables:
MS information table: saves subscriber information (includes subscription information and location information) of the MS;
MSRN information table: saves the record number of the MS information table corresponding to the MSRN and the assignment state of the MSRN.

The relationship between the above two tables is as follows:

MS information table:

| | | | | |
|---|---|---|---|---|
| Record number of | MS | Subscription | Information of | |
| a MS information | subscriber | information of | the current | |
| table | identffication | a MS | location of a MS | . . . |

MSRN information table:

| | | |
|---|---|---|
| | Assignment | |
| Record number of a | state of a | Record number of a |
| MSRN information table | MSRN | MS information table |

The two tables are interrelated through the record number of a MS information table.

The VLR sub-number and the record number of a MSRN information table has a one-to-one correspondence relationship, for example:
VLR sub-number=Record number of a MSRN information table

The assignment manner of a MSRN is very simple, when a VLR receives from a HLR the request to provide a MSRN, it scans the MSRN information table to find an idle record, combines the CC, NDC, MSC number and this record number into a MSRN and provides it to the HLR. When the capacity of the VLR is relatively small and is processed with a centralized database, this kind of manner to assign a MSRN is suitable, but with the continuously capacity expansion of the mobile communication network, the capacity of the MSC/VLR is also gradually expanding, when the capacity of the MSC/VLR becomes large, in order to improve the scalability and the reliability of the system, the VLR is generally realized with a distributed database, this kind of method to assign a MSRN is not suitable.

First, look at the system structure of a large capacity MSC/VLR, as shown in FIG. 3, MSC1, MSC2 . . . MSCm (m is an integer greater than zero) and VLR1, VLR2 . . . VLRn (n is an integer greater than zero) communicates with each other through an internal high speed communication network, since the VLR database is distributed on multiple modules (each module is an real time database) VLR1, VLR2 . . . VLRn (n is an integer greater than zero), the MS information table is certainly stored on multiple modules. But since the MSRN is the common resource of the subscriber controlled by the VLR, the design of a MSRN information table is often resolved by employing a centralized management method and a simple fragmentation management method. If the centralized management method is employed, the MSRN information table is placed in certain VLRi (i is an integer greater than zero), using this manner, when a VLR module number is added in the MSRN information table and when assigning and searching a MSRN, each of the MSC modules must be processed in this VLRi, and after the search result is returned, continues to search the subscriber information of a MS in certain VLRm that stores the record of the MS, the message amount between modules is large, the efficiency is low and there is single point of failure. If the simple fragmentation management method is employed, the MSRN resource is fragmentized, each VLR module controls one piece of fragment, when a VMSC needs to query a VLR, it first obtains the module number of the VLR according to the fragmentation relationship of the MSRN and the queried MSRN, then it queries this VLR module, although this method has solved the problem of single point of failure and efficiency, it brings difficulty to the capacity expansion and failure maintenance of respective systems, when a VLR module needs to be added or removed, the fragmentation relationship of the MSRN must be changed which will influence other VLR modules and will cause call lose during capacity expansion, and smooth capacity expansion cannot be realized.

### SUMMARY OF THE INVENTION

The purpose of the invention is to resolve the technical problem that the existing method for assigning a mobile subscriber roaming number is not suitable for a MSC/VLR with large capacity, and a method for assigning a mobile subscriber roaming number is proposed.

The technical solution taken to realize the technical problem to be solved by the invention is summarized as follows:

In one aspect, there is provided a method for assigning a mobile subscriber roaming number, wherein in a Visitor Location Register, the mobile subscriber roaming number is managed by a plurality of Visitor Location Register modules, said mobile subscriber roaming number comprises a Visitor Location Register module number, and said Visitor Location Register module number is utilized to directly determine the correspondence relationship between said assigned mobile subscriber roaming number and the Visitor Location Register module in said Visitor Location Register that manages said mobile subscriber roaming number.

Preferably, said method comprising the following steps: said Visitor Location Register receives from a Home Location Register a request to assign a roaming number for a mobile subscriber; said Visitor Location Register forwards the request to one of the Visitor Location Register modules; said Visitor Location Register module records the information corresponding to said mobile subscriber and obtains its corresponding VLR sub-number; said Visitor Location Register module generates a mobile subscriber roaming number, said mobile subscriber roaming number comprises a country code, the number of a Mobile Switching Center where said mobile subscriber is in, said VLR sub-number, the module number of said Visitor Location Register module; said Visitor Location Register module returns said mobile subscriber roaming number to said Home Location Register.

Preferably, said recording step further comprising: said Visitor Location Register module records the information of said mobile subscriber in an idle record in a mobile subscriber roaming number information table, and obtains the VLR sub-number corresponding to said record.

Preferably, said Visitor Location Register is a multi-module-clustered distributed real time database. The length of the module number of said Visitor Location Register module may be one bit or multiple bits. The length of said mobile subscriber roaming number is not longer than 15 bits.

In another aspect, accordingly, there is provided a method for searching a mobile subscriber roaming number, wherein in a Visitor Location Register, the mobile subscriber roaming number is managed by a plurality of Visitor Location Register modules, said mobile subscriber roaming number comprises a Visitor Location Register module number, and said Visitor Location Register module number is utilized to directly find the Visitor Location Register module in said Visitor Location Register that manages said mobile subscriber roaming number, thereby obtains the information of said mobile subscriber.

Preferably, said method comprising the following steps: based on said mobile subscriber roaming number, a Visitor Mobile Switching Center initiates a query to the Visitor Location Register module corresponding to said mobile subscriber roaming number; said Visitor Location Register module searches the information of corresponding mobile subscriber based on said mobile subscriber roaming number, and returns it to said Visitor Mobile Switching Center.

Preferably, said step of initiating a query further comprising: said Visitor Mobile Switching Center decomposes said mobile subscriber roaming number into a country code, a Mobile Switching Center number and a Visitor Location Register module number based on the assignment format of said mobile subscriber roaming number; said Visitor Mobile Switching Center sends the query request to the Visitor Location Register module corresponded to said Visitor Location Register module number.

Preferably, said searching step further comprising: said Visitor Location Register module obtains the VLR sub-number in said mobile subscriber roaming number, and obtains the information of said mobile subscriber in the record of the mobile subscriber roaming number information table corresponded to said VLR sub-number, and returns it to said Visitor Mobile Switching Center; said Visitor Location Register module releases said VLR sub-number.

With the technical solution of the present invention, the flow of the call process in a VMSC is simplified, the problem in the MSRN's centralized management and simple fragmentation management is eliminated, efficiency is improved and smooth capacity expansion can be realized, while the reliability and stability of the system is improved.

### BRIEF DESCRIPTION OF THE DRAWINGS

FIG. 1 illustrates a schematic diagram of a mobile communication system;

FIG. 2 illustrates a diagram of the mobile called call process of the mobile communication system;

FIG. 3 illustrates a system structure diagram of a large capacity MSC/VLR.

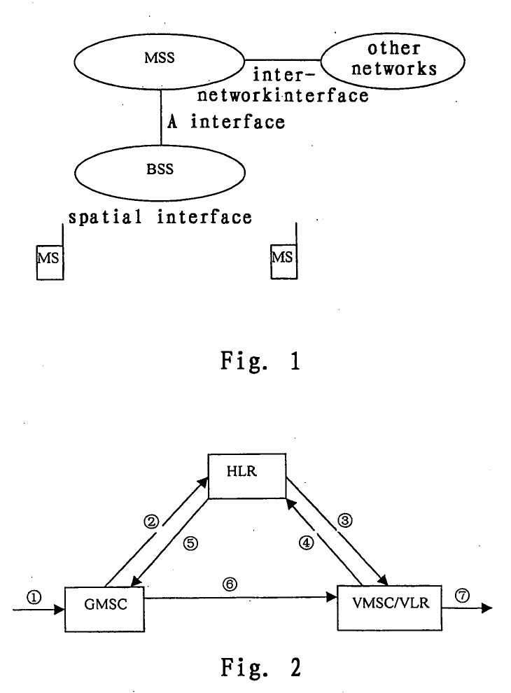

### DETAILED DESCRIPTION OF THE PREFERRED EMBODIMENTS

Next, detailed implementation of the invention will be illustrated in conjunction with accompany drawings.

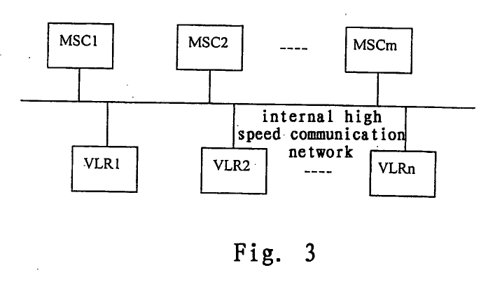

Referring to the logical structure diagram of the large capacity MSC/VLR in FIG. 3, a new MSRN fragmentation manner is proposed in which the module number of a VLR is directly put into a MSRN, thus the structure of the MSRN is as follows:
MSRN=CC+MSC number+VLR module number+MSRN information table record number

Since the ITU-T has limited the length of a MSISDN to 15 bits, the length of the MSRN in the present invention is also limited to 15 bits, which is enough in practical applications. Thus, both the assignment and search of a MSRN become as simple as a single module, a VLR's capacity expansion and maintenance becomes simple, which is illustrated as follows:

First, the assignment process of the MSRN in the invention, the assignment of a MSRN is similar to a single module, when each VLR module receives a request to provide a MSRN, the following steps will be performed:

The first step: finds an idle MSRN information table record;

The second step: occupies this MSRN information table record, and fills the MS information table record number;

The third step: combines a MSRN based on the CC, the MSC number, present VLR's module number, assigned MSRN information table record number and provides it to a HLR.

Correspondingly, in the process of searching a MSRN in the invention, when a VMSC receives a MSRN number, the following process will be performed:

The first step: decomposes the number, after the VMSC has received an in-call request signaling, if it is determined from the number that the number is a MSRN, then the MSRN is decomposed into a CC, a MSC number, a VLR module number v1v2 and a MSRN information table record number abc according to the format of the MSRN;

The second step: the VMSC initiates a query to this VLRv1v2 based on the VLR module number v1v2 (with the MSC module number, a call instance number (the instance established for each call by the MSC, to control the call) and the MSRN information table record number abc);

The third step: searches the information of the MS, after the VLRv1v2 has received the query request, it queries the MSRN information table based on the MSRN information table record number abc and obtains the MS information table record number; the VLRv1v2 searches the MS information table based on the MS information table record number; the VLRv1v2 returns the current information of the MS to the call instance of the MSCn; the VLRv1v2 takes back and releases this MSRN.

After the search is completed, the VMSC initiates a call to the corresponding BSS based on the location area where the MS is currently in to call the MS.

Next, a more detailed implementation is given.

For example, a MSRN number is designed as follows:
MSRN=c1c2n1n2n3m1m2m3m4m5v1v2abc

Wherein,
c1c2: country code, for example, China is 86;
n1n2n3: national district code, for example, China is 130-9;
m1m2m3m4m5: the number of the MSC, which is assigned by the operator;
v1v2: VLR module number;
abc: MSRN information table record number;
the length of the whole MSRN in the above is 15 bits. Generally, the format of the CC, MSC number is decided by the configuration of the mobile communication network, which could not be modified by the MSC and the VLR, a specific network needs to be set according to the specification of corresponding countries.

Since the v1v2 is 2 bits, up to 99 VLR modules (number segment is 01-99) can be in operation at this time.

Assume if the NDC is configured as 139, the MSC number is configured as 00516, then according to the multi-module structure of the MSC/VLR in FIG. 3, the assignment relationship of the MSRN is as follows:

| VLR module | The MSRN range |
|---|---|
| number | controlled by this VLR |
| VLR1 | 861390051601xxx |
| VLR2 | 861390051602xxx |
| . . . | |
| VLR99 | 861390051699xxx |

Using the technical solution of the present invention, for a VLR's capacity expansion and maintenance, the following method can be employed: when a VLR module needs to be added or when a VLR module needs to be removed due to failure, as long as the module number of other VLR modules are not changed, there won't be any influence to other VLR modules, thus, smooth capacity expansion and maintenance of a VLR can be successfully realized.

In summary, with the technical solution of the present invention, the flow of the call process in a VMSC is simplified, the problem in the MSRN's centralized management and simple fragmentation management is eliminated, efficiency is improved and smooth capacity expansion can be realized, while the reliability and stability of the system is improved.

Although the disclosed method related to assign a mobile subscriber roaming number is specifically described in conjunction with the embodiments, those skilled in the art will appreciate that various apparent modifications in form and detail can be made without departing from the scope and spirit of the invention. Accordingly, the embodiment described above is illustrative and is not limited thereto; all changes and modifications are within the scope of the invention without departing from the spirit and scope of the invention.

1. A method for assigning a mobile subscriber roaming number, wherein in a Visitor Location Register, the mobile subscriber roaming number is managed by a plurality of Visitor Location Register modules, characterized in that: said mobile subscriber roaming number comprises a Visitor Location Register module number, and said Visitor Location Register module number is utilized to directly determine the correspondence relationship between said assigned mobile subscriber roaming number and the Visitor Location Register module in said Visitor Location Register that manages said mobile subscriber roaming number.

2. The method according to claim 1, characterized in that, said method comprising the following steps:
said Visitor Location Register receives from a Home Location Register a request to assign a roaming number for a mobile subscriber;
said Visitor Location Register forwards the request to one of the Visitor Location Register modules;
said Visitor Location Register module records the information corresponding to said mobile subscriber and obtains its corresponding VLR sub-number;
said Visitor Location Register module generates a mobile subscriber roaming number, said mobile subscriber roaming number comprises a country code, the number of a Mobile Switching Center where said mobile subscriber is in, the module number of said Visitor Location Register module, said VLR sub-number;
said Visitor Location Register module returns said mobile subscriber roaming number to said Home Location Register.

3. The method according to claim 2, characterized in that, said recording step further comprising:
said Visitor Location Register module records the information of said mobile subscriber in an idle record in a mobile subscriber roaming number information table, and obtains the VLR sub-number corresponding to said record.

4. The method according to claim 1, characterized in that, said Visitor Location Register is a multi-module-clustered distributed real time database.

5. The method according to claim 1, characterized in that, the length of the module number of said Visitor Location Register module may be one bit or multiple bits.

6. The method according to claim 1, characterized in that, the length of said mobile subscriber roaming number is not longer than 15 bits.

7. A method for searching a mobile subscriber roaming number, wherein in a Visitor Location Register, the mobile subscriber roaming number is managed by a plurality of Visitor Location Register modules, characterized in that, said mobile subscriber roaming number comprises a Visitor Location Register module number, and said Visitor Location Register module number is utilized to directly find the Visitor Location Register module in said Visitor Location Register that manages said mobile subscriber roaming number, thereby obtains the information of said mobile subscriber.

8. The method according to claim 7, characterized in that, said method comprising the following steps:
based on said mobile subscriber roaming number, a Visitor Mobile Switching Center initiates a query to the Visitor Location Register module corresponding to said mobile subscriber roaming number;
said Visitor Location Register module searches the information of corresponding mobile subscriber based on said mobile subscriber roaming number, and returns it to said Visitor Mobile Switching Center.

9. The method according to claim 8, characterized in that, said step of initiating a query further comprising:
said Visitor Mobile Switching Center decomposes said mobile subscriber roaming number into a country code, a Mobile Switching Center number and a Visitor Location Register module number based on the assignment format of said mobile subscriber roaming number;
said Visitor Mobile Switching Center sends the query request to the Visitor Location Register module corresponded to said Visitor Location Register module number.

10. The method according to claim 8, characterized in that, said searching step further comprising:
said Visitor Location Register module obtains the VLR sub-number in said mobile subscriber roaming number, and obtains the information of said mobile subscriber in the record of the mobile subscriber roaming number information table corresponded to said VLR sub-number, and returns it to said Visitor Mobile Switching Center;
said Visitor Location Register module releases said VLR sub-number.
